(19) United States
(12) Patent Application Publication
(10) Pub. No.: US 2024/0424561 A1
(43) Pub. Date: Dec. 26, 2024

(54) COMPOSITIONAL CONTROL IN ADDITIVE MANUFACTURING

(71) Applicant: Iowa State University Research Foundation, Inc., Ames, IA (US)

(72) Inventors: Peter C. Collins, Ames, IA (US); Martin Thuo, Apex, NC (US); Katie Rose O'Donnell, Pittsburgh, PA (US); Michael Milan Kirka, Knoxville, TN (US); John Christopher Ledford, Knoxville, TN (US)

(21) Appl. No.: 18/637,135

(22) Filed: Apr. 16, 2024

Related U.S. Application Data
(60) Provisional application No. 63/509,690, filed on Jun. 22, 2023.

(51) Int. Cl. B22F 10/28; B22F 10/366; B22F 10/38; B22F 12/30; B33Y 10/00; B33Y 30/00; B33Y 80/00

(52) U.S. Cl. CPC B22F 10/28; B22F 10/366; B22F 10/38; B22F 12/30; B33Y 10/00; B33Y 30/00; B33Y 80/00

(57) ABSTRACT

Various embodiments relate to additive manufacturing providing compositional control of a material build in three-dimensions. Composition of a material can be controlled in a plane in a spatial manner by directly irradiating the material with an energy beam using a combination of energy scan techniques to volatilize elements of the material away from the material. Such processing can include a change between two distinct scan strategies to produce a spatial variation in composition of the material. Additional systems and methods are disclosed.

### CROSS-REFERENCE TO RELATED APPLICATIONS

This application claims the benefit of U.S. Provisional Application No. 63/509,690, filed 22 Jun. 2023, entitled “COMPOSITIONAL CONTROL IN ADDITIVE MANUFACTURING,” which is incorporated herein by reference in its entirety.

### STATEMENT OF GOVERNMENT SUPPORT

This invention was made with government support under Contract No. N00014-18-1-2794 awarded by the Department of Energy (DOE) and Contract No. DE-AC05-00OR22725 awarded by the DOE. The government has certain rights in the invention.

### FIELD OF THE INVENTION

The invention relates generally to manufacturing, in particular, to technologies related to additive manufacturing.

### BACKGROUND

Additive manufacturing (AM), also known as 3D printing, relates to manufacturing technologies that construct three dimensional (3D) objects by adding material in a layer-upon-layer format. Different AM technologies include the use of a computer, 3D modeling software such as computer aided design (CAD), machine equipment, and material that can be layered. Typically, AM equipment reads in data from a CAD file and forms successive layers of liquid, powder, sheet material, or other material, in a layer-upon-layer fashion, to fabricate a 3D object. AM encompasses many technologies including such techniques as 3D printing, rapid prototyping (RP), direct digital manufacturing (DDM), layered manufacturing, and additive fabrication.

Mass transport of selective atomic species occurs at the liquid surface in metal-based AM processes. Yet, the processes that control the deposited chemical compositions are rarely described qualitatively, let alone quantitatively, and there does not exist a widely accepted method or approach to predict the composition of as-deposited materials. Complicating the effort to develop a hypothesis to explain and predict the final composition given certain process conditions is the fact that the energy sources vary, and the environments of AM platforms range from vacuums to positive pressure, with varying degrees of purity of “inert atmospheres.”

### BRIEF DESCRIPTION OF THE FIGURES

The drawings, which are not necessarily to scale, illustrate generally, by way of example, but not by way of limitation, various embodiments of the invention in which:

FIG. 1 illustrates an example of compositional control, in accordance with various embodiments.

FIG. 2 illustrates an example of subsequent control of microstructure following annealing, in accordance with various embodiments.

FIG. 3 illustrates elastic modulus control via a spatially resolved acoustic spectroscopy wave speed map, in accordance with various embodiments.

FIG. 4 illustrates plastic deformation control via a Vickers micro hardness map, in accordance with various embodiments.

FIG. 5 illustrates oxidation and corrosion properties, as well as appearance via anodizing, in accordance with various embodiments.

FIG. 6 illustrates an example additive manufacturing system that can be implemented with respect to a first of two variants, in accordance with various embodiments.

FIG. 7 illustrates an example additive manufacturing system that can be implemented with respect to a second of two variants, in accordance with various embodiments.

FIG. 8 illustrates an example arrangement in which an energy beam irradiates an additive manufacturing part forming a molten pool, in accordance with various embodiments.

FIG. 9 illustrates an example segment of a molten pool of FIG. 8 with respect to a process zone, in accordance with various embodiments.

FIG. 10 illustrates an example segment of molten pool of FIG. 8 with respect to a method of controlling evaporation, in accordance with various embodiments.

FIG. 11 illustrates an example segment of molten pool of FIG. 8 with respect to a method of controlling evaporation, in accordance with various embodiments.

FIG. 12 illustrates an example system and functions of the system to perform a material build using an additive manufacturing system, in accordance with various embodiments.

FIG. 13 illustrates an example system and functions of the system to perform a material build using an additive manufacturing system, in accordance with various embodiments.

FIG. 14 is a flow diagram of features of an example method of performing a material build, in accordance with various embodiments.

### DETAILED DESCRIPTION

The following detailed description refers to the accompanying drawings that show, by way of illustration, various embodiments of the invention. These embodiments are described in sufficient detail to enable those of ordinary skill in the art to practice these and other embodiments. Other embodiments may be utilized, and structural, logical, mechanical, and electrical changes may be made to these embodiments. The various embodiments are not necessarily mutually exclusive, as some embodiments can be combined with one or more other embodiments to form new embodiments. The following detailed description is, therefore, not to be taken in a limiting sense.

Increasingly, AM of structural metals is delivering on the original promise of rapidly manufacturing complex parts whose properties are competitive, if not superior to, conventionally manufactured alloys of the same composition. Consequently, multiple economic sectors, including aerospace, biomedical, defense, and energy, are adopting a variety of metals-based additive manufacturing processes into their supply chain. One long-offered promise of AM was the potential to grade the chemical composition within a single specimen to enable location-specific properties and performance in advanced concepts such as unitized structures. While this capability was achieved in directed energy deposition systems through the independent feeding of material feedstock, the mechanical means of composition control have been temporally incongruent with the deposition rates. Consequently, prior studies generally are limited to varying in one direction only, typically the build z-direction, or, if exercised in the x-y build plane for combinatorial purposes, have been adopted for multiple discrete builds where the incoming composition can be tuned prior to the initiation of deposition at an x-y location. These methods rely upon using feedstock of distinctly different compositions, and thus different powder feeders.

In various embodiments of material build, as taught herein, a feedstock with a single composition can be used by controlling process parameters that lead to selective vaporization of alloying elements, which can achieve composition control within the x-y build plane of a single specimen. As z-control has been demonstrated previously, this disclosure closes the loop, demonstrating control of composition within a single build for any x, y, z position. Such processing can include a change between two distinct scan strategies to produce a deposition from a single composition. Concurrently, such techniques can provide an ability to control the clastic and plastic properties of the material locally, not only in the as-deposited condition but also through subsequent heat-treatments. This control can influence subsequent microstructural evolution following annealing, as well as the evolution of surface oxides through anodization. This approach to control composition using the process itself, as opposed to mechanical triggering, has the following significant impacts. Firstly, it can be exploited for a wide range of alloys, and can usher in new alloy design strategies. Secondly, it provides a way to control composition in powder-bed processes, a capability that, heretofore, has not been practical. Lastly, it motivates incorporation of mass transfer across the liquid-environment interface, especially for AM processes that occur under vacuum.

During fusion-based AM of metals, a material precursor (powder or wire) is melted in an environment, such as vacuum or shield gas, using an energy source such as an electron beam, a laser, or a plasma arc. The material can either be fed continuously, such as occurs in directed energy deposition, or fed in a layer-by-layer fashion, such as occurs in powder bed fusion. The superheat, i.e., the temperature of the molten pool relative to the melting point, can reach 500° C.-2000° C. These conditions are sufficient to change the composition of the molten pool, through either gettering of elements from or evaporative loss of the elements to the surrounding environment. The traditional way that this compositional modification has been understood is that of the Langmuir approach in which a multi-phase interface, for example a liquid-AM environment, mediates the transport of atoms through either absorption or evaporation to achieve thermodynamic equilibrium between the phases present. Within the general AM community, the impact of these solute changes have been limited to understanding and predicting loss of volatile species or increasing oxygen content in powder when material is to be reused/recycled.

The digital nature of AM offers the potential to control spatially the alloy composition, and thus potentially properties and performance. The ability to control the properties of a material spatially makes possible structures such as functionally graded materials, hierarchical materials, and unitized structures. The potential to spatially control alloy composition was first demonstrated during combinatorial studies of composition-microstructure-property relationships in titanium alloys using powder-blown, laser-based directed energy deposition (DED) systems. In DED systems, the ability to independently control material feed rates of different alloys (either pre-alloyed or elemental blends) makes it possible to integrate the control of the composition into the machine code. However, the technical details associated with, for example, limitations in machine code and the mechanisms associated with controlling material feed rates results in a time lag between the setting of a feed rate and the realization of a change in feed rate at the molten pool. Thus, the control of composition in DED tends to be limited to two approaches. Firstly, composition gradients are produced along the primary build axis, which is typically the z-axis for a cartesian reference frame or the r-axis for polar or spherical, depending upon the degrees of freedom within a DED build envelope. Secondly, when this build-axis paradigm is challenged and composition is changed within a single z-layer, multiple discrete specimens are manufactured, each with a different composition and a physical separation between specimens (i.e., the hatch space of the z-layer is discontinuous, giving time to adjust feed rate). In both cases, there is a sufficient process delay, whether between layers or between locations, respectively, and initiation of discrete, sequential process steps to enable the material feed rate to reach the set point prior to the initiation of a new vector. More recently, researchers have demonstrated an ability to produce composition gradients in laser powder bed fusion through novel powder spreading techniques, including mechanical separates in the powder dispensing system to achieve various gradients, including in-plane compositional control. While not implemented on all variants of AM systems, one can conceive relatively simple mechanical means by which the delivery of the material feedstock can be controlled. Of note, for all powder based approaches, DED and powder bed fusion (PBF), any reclaimed powder will have different constituents present, which would require separation prior to powder recycling.

Research on electron beam powder bed fusion (e-PBF) has shown that changes in scan strategy can affect the as-deposited composition of a titanium (Ti)-aluminum (Al)-vanadium (V) alloy, namely Ti-6A1-4V (Ti64). This literature is in agreement with other research from large-scale electron beam additive manufacturing, where it is known that aluminum preferentially volatilizes. Of importance, the scan strategy in e-PBF can be changed with a spatial precision that is better than the dimensions of the molten pool (tens of microns). Previously, these changes have been used to demonstrate the ability to control the local texture of a material by controlling the thermal gradients, as researchers spatially engineered the solidification modes (equiaxed vs. columnar) and affected the letters “DOE” in an e-PBF nickel (Ni) build.

In various embodiments, the physical differences that exist both within (temperature) and above (vapor) the molten pool can be exploited to demonstrate that it is also possible to similarly “write in” composition into the x-y build plane. Ti-6Al-4V is a suitable model system to demonstrate this ability for a few reasons. Firstly, it is the most widely used titanium alloy, and consequently is easy to obtain powder. Secondly, it has been well-established that aluminum preferentially vaporizes, though this vaporization has not been spatially controlled. In addition, because of the balance of alloying elements, the microstructure is highly tunable, and is able to be thermomechanically processed in different ways to achieve microstructures that are dominated by a colony microstructure, a basketweave microstructure, or a microstructure consisting of equiaxed alpha particles in transformed beta. Using a single Ti-6A1-4V powder feedstock, and by modifying the scan strategy at precise x, y positions within each z-layer, the ability to write in composition has successfully been demonstrated herein.

Thirty-six samples of electron beam melted (EBM) Ti-6A1-4V (Ti64) were built using an Arcam EBM Q10plus system at Oak Ridge National Laboratory's Manufacturing Demonstration Facility as part of an Office of Naval Research funded Multi-University Research Initiative (MURI) project. All samples were built in the same chamber, on the same stainless steel build plate, using three different scan strategies to produce twelve samples for each strategy. The three different scan strategies used were a linear raster scan labelled “L,” random point-melting scan labelled “R,” and a Dehoff point-melting, an ordered point-melting strategy labelled “D.” These samples were distributed among partner universities involved in testing, with three samples provided, one of each scan strategy, given to the Iowa State University (ISU) team lead by the inventors.

All samples had the same geometry, which was of a rectangular prism having dimensions of 15 mm×15 mm×25 mm, the same layer thickness of 50 μm, and experienced the same preheat temperature and ambient build chamber pressure of 470° C. and 4.5×10⁻² mBar. The L samples were built first within each layer at the same time for all twelve samples, but the R and D samples were separated into subgroups of three samples each.

At ISU, the three samples (L5, R5, and D5) were sectioned parallel to the build direction to reveal the internal XY planes. Two halves were created from each sample, each with a resulting geometry of 7.5 mm×15 mm×25 mm, and the exposed planes were polished and analyzed.

Energy dispersive spectroscopy (EDS) analysis was performed providing results of compositional analysis. These analyses were conducted on the sectioned, interior surfaces of each build. While Al loss was anticipated relative to the initial feedstock material, it was expected that the raster sample would experience the higher Al loss comparatively. Contrary to what was expected, both of the point-melting strategies experienced a greater Al loss as shown in Table 1.

TABLE 1

| | Ti | Al | V |
|---|---|---|---|
| L5, Center | 90.77 | 5.56 | 3.67 |
| L5, Edge | 90.81 | 5.51 | 3.68 |
| R5, Center | 91.66 | 4.57 | 3.77 |
| R5, Edge | 91.65 | 4.58 | 3.78 |
| D5, Center | 91.36 | 4.86 | 3.78 |
| D5, Edge | 91.48 | 4.74 | 3.78 |

Elements with high vapor pressures relative to other species present are well known to evaporate during high-temperature processing, such as the conditions generated in additive manufacturing. This has been shown for elements such as zinc and gallium, as well as Al in Ti alloys and chromium (Cr) in stainless steel or Ni-based alloys, both in conventional and additive manufacturing processes. See, for example, Ivanchenko, V. G., Ivasishin, O. M., & Semiatin, S. L. “Evaluation of evaporation losses during electron-beam melting of Ti—Al—V alloys.” Metallurgical and Materials Transactions B, 34 (6), 911-915. (2003).; Damri, Elroei, et al. “Effects of Gas Pressure during Electron Beam Energy Deposition in the EBM Additive Manufacturing Process.” Metals 11.4 (2021): 601; and Nandwana, Peeyush, et al. “Recyclability study on Inconel 718 and Ti-6Al-4V powders for use in electron beam melting.” Metallurgical and Materials Transactions B 47.1 (2016): 754-762. This property was considered in U.S. Pat. No. 11,379,637. Many manufacturers compensate for the known evaporation properties of high vapor pressure elements by increasing the quantity of these elements in the feedstock material, ensuring the final composition, despite element loss, is as desired. See, for example, Brice, C. A., Rosenberger, B. T., Sankaran, S. N., Taminger, K. M., Woods, B., & Nasserrafi, R. “Chemistry control in electron beam deposited Ti alloys.” Materials Science Forum (Vol. 618, pp. 155-158). Trans Tech Publications Ltd (2009). This preferential vaporization is also used to remove impurity elements, for elements such as oxygen in Ti alloys, as well as inclusions. See, for example, Powell IV, A. C. “Transport phenomena in electron beam melting and evaporation.” Doctoral dissertation, Massachusetts Institute of Technology) (1997).

In addition to the vaporization of elements during high-temperature manufacturing processes, there are other processes which rely on the vaporization of molten metals, such as electron beam physical vapor deposition and other similar techniques. See, for example, Powell above. While these techniques do not generally rely on preferential vaporization of select elements from feedstock material, they can be used to elucidate vaporization processes in general, particularly for metals and alloys.

The preferential vaporization of elements from Ti—Al alloys, primarily Al but also impurity elements such as oxygen (O) is discussed herein. Such discussions can be applied to other elements in different alloys.

Ideal vaporization can be modeled with what is commonly known as the Lagmuir equation:

$${W}_{i} ( kg / {m}^{2} s ) = {{P}_{i} [ {M}_{i} / ( 2 π RT ) ]}^{1 / 2} , \qquad ( 1 )$$

where Pi is the partial pressure of the vapor of species i, Mi is the molar fraction of the species, R is the ideal gas constant, and T is the temperature. See above, for example, Ivanchenko. This equation can be further broken down by giving the calculation of the partial pressure of a particular species:

$${P}_{i} = {X}_{i} {γ}_{i} {P}^{o} \qquad ( 2 )$$

where Xi is the molar fraction, γi is the activity coefficient, and P^{o}ᵢ is the partial pressure of the species for the pure element, which can itself be further expanded. See above, for example, Ivanchenko. The partial pressure of pure Al is as shown (although the equation is not specific to Al):

$${P}_{Al}^{o} = 133 \times {10}^{( - A / T + B )} {T}^{C} , \qquad ( 3 )$$

where A, B, and C are material constants. See above, for example, Ivanchenko. As such, expanding equation (1) for Al, by incorporating equations (2) and (3), yields the following result:

$${W}_{Al} ( kg / {m}^{2} s ) = {X}_{A l} {{γ}_{A l} ( 133 \times 1 {0}^{( - A / T + B )} {T}^{C} ) [ {M}_{Al} / ( 2 π RT ) ]}^{1 / 2} \qquad ( 4 )$$

Extensive work has been performed in the literature to solve equation (1) for the primary components of a Ti—Al—V alloy. See above, for example, Ivanchenko. One such effort is shown, from Ivanchenko, as curves of evaporation rate versus temperature over the temperature range from about 1950° K to about 2400° K visualizing higher evaporation rates of Al as compared to Ti and V, where Al has higher evaporation rates compared to Ti and V. Indeed, V has a much lower evaporation rate than either Ti or Al, accounting for its relative compositional stability as seen in Table 1. Such evaporation rate curves show model predictions of the temperature dependence of the rate of evaporation of Al, Ti, and V from liquid Ti-6Al-4V (wt pct) based on the Langmuir equation and thermodynamic estimates of the activity coefficients, from Ivanchenko above.

It should also be noted that the effect of temperature on evaporation rates can be perturbed by other factors in addition to vapor pressure, such as atomic radius and reduction potentials (E⁰). If one was only concerned with the evaporation of Al within molten pools, these could be neglected, as the properties would be identical. However, Al is not the only species of interest in the samples mentioned above. Impurity elements in the alloy, oxygen in particular, may also contribute to the observed compositional differences, and, due to the aforementioned properties as well as equation (1) above, will differ from Al in their evaporation rate.

Returning to the Lagmuir equation, for the scenario outlined previously and only focusing on Al vaporization, all of the variables within equation (4) will be identical between samples L5, R5, and D5, with the exception of the temperature of the melt pool for each build. Melt pool temperature is itself a factor of scanning strategy, speed, and power, and therefore will vary, particularly between the linear and point-melting strategies, which result in different melt pool morphologies. Generalizing, the linear melt pool is expected to have a higher temperature than either of the point-melt pool varieties, given heat accumulation from adjacent linear scans and a more rapid re-melting cycle. See, for example, Quintana, Maria J., et al. “Texture analysis of additively manufactured Ti-6Al-4V deposited using different scanning strategies.” Metallurgical and Materials Transactions A 51.12 (2020): 6574-6583; and Kamath, Rakesh R., et al. “Solidification texture, variant selection, and phase fraction in a spot-melt electron-beam powder bed fusion processed Ti-6Al-4V.” Additive Manufacturing 46 (2021):102136.

As such, in the case of ideal vaporization, it can be assumed that temperature is mainly responsible for differences in Al content. However, ideal conditions are rarely realized and this proves to be the case for the samples described herein as well. Given that higher temperatures would increase vaporization rates, and that the linear sample melt pools are expected to achieve higher temperatures than the other samples, this assumption would lead to the conclusion that the linear sample should experience the greatest Al loss. As seen in Table 1, this is not the case: the random point-melting sample experienced the greatest Al loss, followed by the Dehoff point-melting sample. The linear sample lost the least Al, comparatively. Clearly, some physical, kinetic, or chemical phenomenon is occurring which significantly deviates the vaporization from the ideal, as modeled by the Langmuir equation. These physical, kinetic, or chemical phenomenon can act independently or synergistically.

There are several factors in non-ideal scenarios that are not accounted for in the Langmuir equation that can have an influence on resulting evaporation rates. A first factor is the time at temperature. The cooling rate of molten materials, if they are high enough, can deviate from thermodynamic equilibrium into the realm of kinetics. Very high cooling rates can significantly impair evaporation, particularly as the cooling rate may exceed diffusion or mixing time scales, preventing new species from being brought to the surface before solidification and thereby limiting evaporation. The cooling rate for the linear sample is expected to be greater than that of the point-melting samples, which may account for some of the difference in composition, however they are within an order of magnitude in similarity (1×10⁵K/s and 7×10⁴K/s, respectively). See, for example, Quintana above.

A second factor is the size and geometry of the melt pool. As evaporation occurs at the surface of any molten liquid, shallower melt pools, i.e., those with a higher surface area to volume ratio, will experience greater overall Al loss, given that the depleted Al layer takes up a greater percentage of the melt pool overall. See, for example, Brice above and Semiatin, S. L., Ivanchenko, V. G., & Ivasishin, O. M. “Diffusion models for evaporation losses during electron-beam melting of alpha/beta-Ti alloys.” Metallurgical and Materials Transactions B, 35(2), 235-245 (2004). However, this is unlikely to be a contributing factor for the given scenario. The linear melt pool is expected to be shallower than the point-melt pools (See for example, Brice above and Semiatin above), again suggesting that it should suffer higher Al loss. In addition, this is again an idealized model, neglecting any mixing that takes place. See, for example Semiatin above.

A third factor is pressure above the melt pool. Higher pressures above melt pools have been shown to both increase the recondensation ratio, defined as the fraction of atoms that return to the surface, as well as increase the temperature necessary for vaporization to occur in the first place. See, for example, Damri and Powell above. As previously stated, all thirty-six samples were built in the same chamber as part of the same build process and thus the ambient atmosphere of the chamber was identical for each sample. However, the differing scan strategies result in different vapor plume morphologies, i.e., spatial distribution of metallic atoms and/or metallic-rich molecules, for example, oxides immediately above the molten pool. The differing scan strategies resulting in different vapor plume morphologies will have an influence on local pressure and the likelihood that another atom will be volatilized and “escape.” Denser and longer lasting vapor plumes will thus increase local pressure, preserving Al content and mitigating vaporization. This is expected to be the primary mechanism governing Al compositional differences in the samples discussed herein.

A fourth factor is scanning speed. In addition to the three materials parameters discussed above, the influence of a processing parameter, scan speed, on vaporization has also been documented in the literature. It is ultimately the influence that scanning speed has on more fundamental parameters, such as melt pool temperature, cooling rate, melt pool morphology, and local vapor plumes, that accounts for difference in evaporation at different scan speeds. However, scan speed is an easily changeable process parameter and can be used to elucidate the effects of each of the aforementioned fundamental parameters more easily and will thus be mentioned briefly here. Generalizing, higher scan speeds (high scan frequencies) result in less Al loss. See, for example Powell above and Klassen, A., Forster, V. E., Juechter, V., & Körner, C. (2017). “Numerical simulation of multi-component evaporation during selective electron beam melting of TiAl.” Journal of Materials Processing Technology, 247, 280-288. This can be accounted for with the fact that longer beam dwell times lead to higher local superheats (increasing the line energy) and thus higher evaporation rates. Therefore, higher speeds lead to shorter beam dwell times and smaller local superheats. See, for example Powell above and Klassen above.

A fifth factor is the preferential interactivity parameter (PIP) of the three elements and their divergences under a stimuli of light radiation, high shear (from underlying Marangoni flow), and/or high temperature. See, for example, ACS Applied Nano Materials (2022), 5 (3), 3325-3332. Photoexcitation with an appropriate light stimulus may lead to near surface electronic excitation and a shift in the ordinality of the standard reduction potential, hence the preferential vaporization. Similarly, the three stressors (i.e., light radiation, high shear, high temperature) can each affect the interaction potential, w (r), hence the vapor pressure of the alloy components. The resulting differences in the vapor pressures of the alloy components lead to asymmetric diffusion and a redefined free energy space that is largely driven by stochastic responses (i.e., alloy elements largely acting as isolated entities rather than a mixture), hence PIP-biased asymmetric re-distribution of the elements during melting and upon solidification.

The current hypothesis regarding the unexpected variation in Al content is that the differing local atmospheres, or local vapor plumes, resulting from the different scan strategies, are the primary mechanism for the higher Al loss in the point-melting samples.

The raster scan strategy results in a single continuously moving molten pool, which thus generates and equilibrates a vapor plume that “follows” the electron beam. A similar vapor plume would not achieve equilibrium in point-melting strategies, as each molten pool (each point melted) is spatially distinct, generating its own, much smaller (less dense) vapor plume that would then take a sustained exposure to equilibrate (in some sense). The larger (and denser) vapor plume in the raster scan strategy would then act as an “umbrella” (potentially a stratified umbrella consisting of different molecular “complexes” of certain species), or a protective layer, preventing a portion of any evaporating species from leaving the local environment and therefore mitigating the effects of preferential vaporization. This mechanism would lead to the results as shown in Table 1, where the L5 sample had significantly less Al loss than the R5 or D5 samples but still suffered some Al loss compared to the initial composition of the powder used in the build. This mechanism is consistent with the phenomenon discussed above with respect to factors influencing ideal vaporization, where higher local pressure above a melt pool results in less vaporization overall.

Recalling the effect of scan speed on Al vaporization, some important work has also been conducted and is presented in the literature about the effect of scan speed on the evolution of the resulting vapor plume. See, for example Zheng, Hang, et al. “Effects of scan speed on vapor plume behavior and spatter generation in laser powder bed fusion additive manufacturing.” Journal of Manufacturing Processes 36 (2018): 60-67. An example of such work is provided in Zheng, which shows images of plume and spatters during track formation under different scan speeds, where the images have been superimposed. Images were shown for a laser beam that scans horizontally from a powder bed on the left to a bare substrate on the right. Frames of the laser spot in the middle of each track were manually removed for clarity by Zheng. The images on the left showed 25 plumes of approximately 15 mm evenly distributed on powder bed, while the images on the right showed 15 plumes of approximately 10 mm on the substrate along the track, where the temporal interval of frames was selected correspondingly. While this work did not compare point-melting plumes with linear plumes, the initial plume can be used to approximate a point-melting plume. The vapor plume angles stretched out over the previously melted portions of the track, whereas the initial vapor plumes were nearly vertical in nature. This supports the current hypothesis that linear scans result in vapor plumes above the molten pool, contributing to either recondensation or a “throttling” of solute loss, while the point-melting scans do not feel the influence of increased local pressure from nearby vapor plumes as strongly. It should be noted that this example from the literature is an example of laser-induced vapor plumes, not an electron beam. However, the general trend still holds.

This vapor plume consists of both Al as well as impurity vapor species, primarily oxygen, and that the stratified umbrella therefore consists primarily of Al, AlOx (Al oxide and sub-oxides), which allows for greater condensation and thus less Al loss overall. These oxides are fully oxidized and partially oxidized Al species. See, for example, Chem. Mat. (2020), 32(21) 9045-9055 and Surf. Interface Anal. (2017) 49, 1309-1315).

In various embodiments, an apparatus can be introduced into an AM chamber which purposefully generates, stabilizes, or accelerates the attainment of equilibrium of a protective vapor layer above molten pools using other species with relatively high vapor pressures. Such other species can include, but are not limited to, gallium (Ga), zinc (Zn), and other appropriate elements. Implementation of such an apparatus can lead to far greater compositional control in AM samples and limiting preferential vaporization of high vapor pressure elements.

The existing state-of-the-art approach to controlling composition of material spatially is to introduce materials of different compositions, such as of two different alloys, either through pre-alloyed means, such as powder and wire, or blends of elemental material stock. While existing systems can theoretically change the materials being introduced at every x, y, z position, the response of the material handling systems (such as powder feeders) is far slower than the speed of additive manufacturing, meaning that it is virtually impossible, in the existing systems, to control spatially the composition within the x-y plane and create a fully dense part. Thus, systems are generally limited to controlling composition of the as-deposited material in either the z-direction, where pauses between layers is sufficient time to reach a new “equilibrium” in incoming material flow rate, or creating discrete depositions in the x-y plane, each with a unique composition or unique graded composition.

In various embodiments, controlling composition through controlling the environment surrounding the molten pool, including the vapor, creates a new opportunity to control the composition of material spatially. A system can be implemented that changes the composition in the x-y plane (as well as z plane), enabling precise spatial control of composition in all possible build directions. Such a system can be based upon exploiting the thermodynamics and vapor, through scan strategies or attainment of equilibrium of a protective vapor layer above molten pools using other species with relatively high vapor pressures, to control composition locally. A hybrid scan procedure can be used to implement changes in composition in the x-y plane. A hybrid scan procedure can include, but it is not limited to, a raster scan and a random scan. A random scan is a technique in which an energy beam, such as but not limited to an electron beam, is directed to one or more specific areas of the material being processed. For example, a raster scan can be used to form one or more patterns of regions followed by a random scan to control composition within the regions.

Preliminary work replicating the initial results discussed at the beginning of this disclosure, where the point-melting strategies have a great Al vaporization, was conducted. Four new samples were built using the same process parameters as the initial samples, but containing both the raster and random scan strategies within each individual sample. The bulk of each of these blocks was built using the raster scan strategy, while the random scan strategy was used to ‘write in’ composition, so to speak, through controlling the environment surrounding the molten pool in the form of the acronym MURI in the x-y plane.

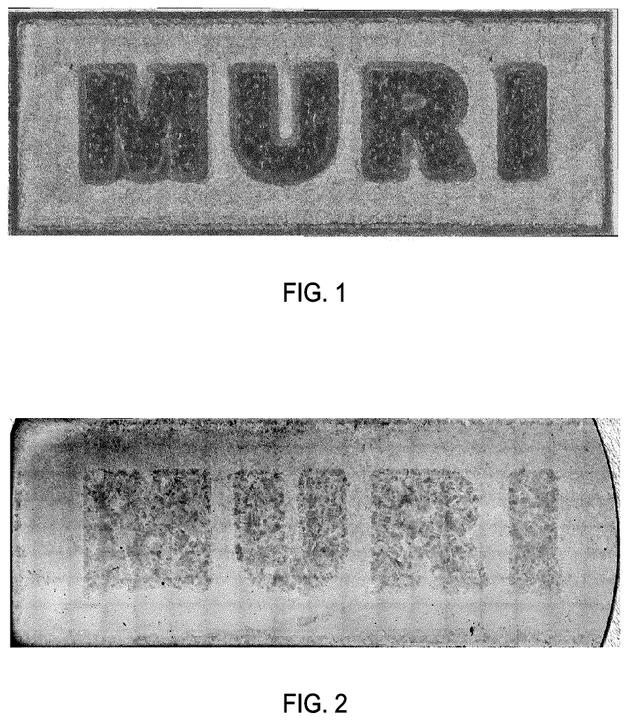

In various embodiments, composition can be controlled through evaporation, which is a loss mechanism, or adsorption, which is a gain mechanism, or combinations thereof, and precise control of the surrounding environment. The composition in the as-deposited material can vary spatially, even though the deposition can be made using only a single starting alloy composition. FIG. 1 illustrates an example of compositional control. In such cases, only one supplier of alloy feedstock (powder, wire) is sourced. This can provide an ability to tune out-of-specification alloy feedstock compositions to specification by changing the process parameters. Sufficiently mature process monitors can be implemented to identify an out-of-specification alloy feedstock, and evolve the process parameters to make the alloy to meet specification. By controlling evaporation or adsorption, composition can be changed in a more discrete, spatially resolved (localized) volumetric sense than mechanical means of composition control. In various embodiments, resolution can be tuned by melt pool size. The same observations can be expected from the sub-micron level to the centimeter level.

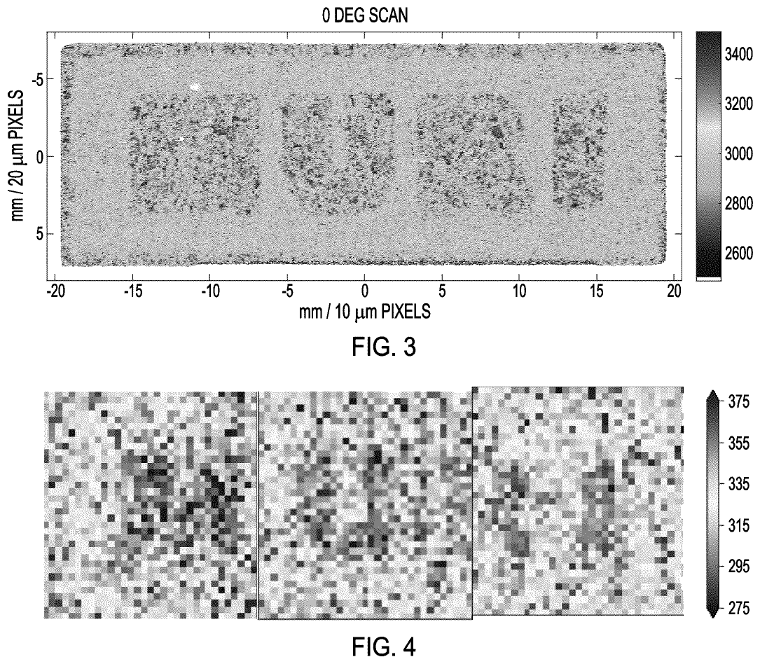

Changes in composition can lead to attending changes in microstructure and materials state, including, but not limited to, phase, grain size, grain texture/orientation, grain boundary character distributions, and various other defects. Phase can include fraction, size, or morphology. FIG. 2 illustrates subsequent control of microstructure following annealing. These differences can be observed during the time of manufacture, in the as-deposited condition, in processes involving thermal treatments or thermal plus mechanical treatments conditions, and after time in service at elevated temperatures. Thermal treatments can include, but are not limited to, aging and annealing. Thermal plus mechanical treatments can include, but are not limited to, forging, rolling, and extrusion. Changes in composition can lead to changes in thermophysical properties, including, but not limited to, melting points, solid-state phase fields and transformation temperatures, and surface energies. Chances in composition can lead to changes in properties, including, but not limited to, elastic mechanical properties, plastic mechanical properties, thermal properties, electrical properties, optical properties, and magnetic properties. FIG. 3 illustrates elastic modulus control via a spatially resolved acoustic spectroscopy (SRAS) wave speed map. FIG. 4 illustrates plastic deformation control via a Vickers micro hardness map.

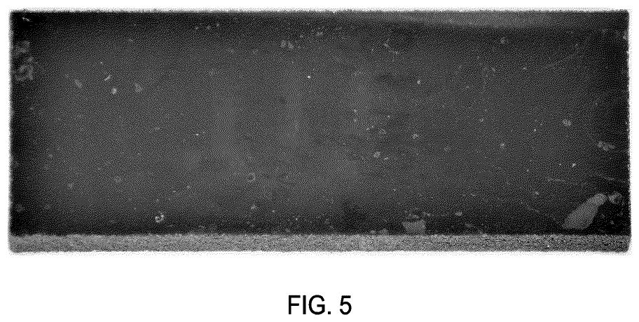

Changes in composition can be exploited in secondary processing techniques to achieve subsequent local microstructural control. For example, changing composition can change transus temperatures in structural alloys, permitting thermomechanical processing at the same temperature but for different phase stabilities/microstructures/mechanical response. A transus temperature is the temperature at which a composition transforms from one phase to another phase such as from its alpha phase to its beta phase. For example, it may be possible to induce local control of strain during forging operations but at a single temperature. Changing composition can change the response of the material to electrochemical environments resulting in changes for engineering or aesthetic benefit. FIG. 5 illustrates oxidation and corrosion properties, as well as appearance via anodizing. FIG. 5 shows EDS mapping of the surface of a produced block. The random scan strategy was used to write the acronym “MURI” in the sample, which can be seen in the Al counts due to the higher vaporization the random scan strategy experiences. Such electrochemical environments can include corrosion, oxidation, cathodic or anodic protection, anodization, or combinations thereof.

In various embodiments, evaporative loss can be controlled by means of real-time tools, predictive tools, or hybrid sensor-data controls. Real time techniques can include chemical measurement techniques, non-contact, non-invasive measurement techniques, cyber-physical hardware/software, or combinations thereof. Such chemical measurement techniques can rely upon spectroscopy. Non-contact, non-invasive measurement techniques can include nondestructive evaluation (NDE)-based variants. Cyber-physical hardware/software can be implemented that measures a property dependent upon composition, for example, but not limited to, transus temperature. Predictive tools can include physical models, process-composition artificial intelligence and machine learning (AI/ML) derived relationships, or combinations thereof. Evaporation can also serve a separate advantage in AM systems. For example, if a particular volatile species is desired to be maintained at compositions near the starting composition of a powder, by control of a plume with a high partial pressure of the particular species, the loss from the primary deposition would be greatly reduced or, under the right conditions, eliminated. The particular volatile species can be from metal-containing gases or a second, sacrificial volatilized source.

Controlling loss can be conducted for any atomic species that is considered volatile under the conditions of the process. The atomic species can include desirable and undesirable interstitial elements and substitutional elements of a vaporization temperature. The desirable and undesirable interstitial elements can include, but are not limited to, O, nitrogen (N), boron (B), carbon (C), and hydrogen (H). The desirable and undesirable substitutional elements of a vaporization temperature can include, but are not limited to, Al, Cr in Ti, Ni, iron (Fc), and cobalt (Co).

In various embodiments, adsorption can be controlled by the introduction of a metal-containing gas that is patterned onto the deposition either prior to deposition (solid) or during deposition (liquid). Examples of metal-containing gases include tungsten (W)-hexacarbonyls, Cr-hexacarbonyls, molybdenum (Mo)-hexacarbonyls, where (W, Mo, Cr)-hexacarbonyls become liquid at extremely low temperatures, and can be injected into the vacuum, electron-beam deposited, and then thermally decomposed. In regions that were not irradiated by the electron beam, the species would be removed by the vacuum of the electron beam system. Analogies to the adsorption can include gas injection systems, which can be used for focused ion beam (FIB) microscopes. Adsorption can also be introduced by a second melting/evaporation system, where the metal containing vapor can be directed towards the primary deposit, and adsorbed through various known physical mechanisms.

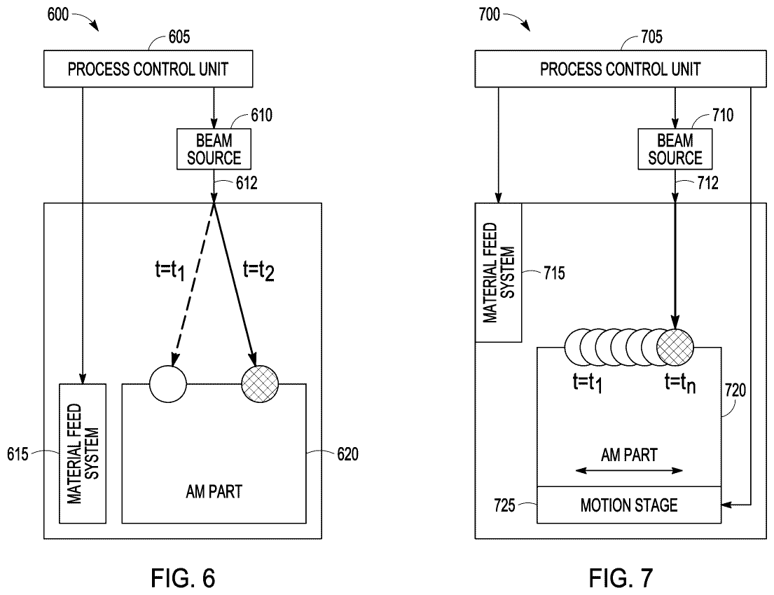

FIG. 6 illustrates an embodiment of an example AM system 600 that can be implemented with respect to a first of two variants, which can be implemented in arrangements involving liquids for example. AM system 600 can include a process control unit 605. Process control unit 605 can be coupled to a material feed system 615 and can be structured to control material feed from material feed system 615 for processing. Process control unit 605 can also be coupled to a beam source 610 and can be structured to control an energy beam 612 from beam source 610 to an AM part 620 for processing. Process control unit 605 controls energy beam 612 to irradiate one portion of AM part 620 at time t=t₁ and to irradiate another portion of AM part 620 at time t=t₂. The portion of AM part 620 irradiated at the time of exposure operates as a process zone under high energy exposure, such as at t=t₂. The portion of AM part 620 irradiated at a previous time of exposure operates as a process zone that is cooling after high energy exposure, such as at t=t₁. Process control unit 605 and beam source 610 can be structured to selectively change the direction of energy beam 612. Beam source 610 can be integrated into process control unit 605. Beam source 610 can be, but is not limited to, an electron beam source. Other energy beam sources can be used such as one or more laser beam sources or one or more focused ion beam sources. Process control unit 605 can control the times of energy beam irradiation and the direction of irradiation.

FIG. 7 illustrates an embodiment of an example AM system 700 that can be implemented with respect to a second of two variants, which can be implemented in arrangements involving liquids for example. AM system 700 can include a process control unit 705. Process control unit 705 can be coupled to a material feed system 715 and can be structured to control material feed from material feed system 715 for processing. Process control unit 705 can also be coupled to a beam source 710 and can be structured to control an energy beam 712 from beam source 710 to an AM part 720 mounted on a motion stage 725 for processing. Beam source 710 can be structured to provide a fixed beam 712. Process control unit 705 can control motion stage 725 such beam 712 from beam source 710 can be selectively irradiate different portions of AM part 720 at different times, such as from t=t₁ to t=tn. The portion of AM part 720 irradiated at the time of exposure operates as a process zone under high energy exposure, such as at t=tn. The portion of AM part 720 irradiated at a previous times of exposure operates as process zones that are cooling after high energy exposure, such as t=t₁ to a time before t=tn. Beam source 710 can be integrated into process control unit 705. Beam source 710 can be, but is not limited to, an electron beam source. Other energy beam sources can be used such as one or more laser beam sources or one or more focused ion beam sources. Process control unit 705 can control the times of energy beam irradiation and the movement of motion stage 725. Other AM systems can be structured to selectively operate in the variant of AM system 600, AM system 700, or various combinations thereof.

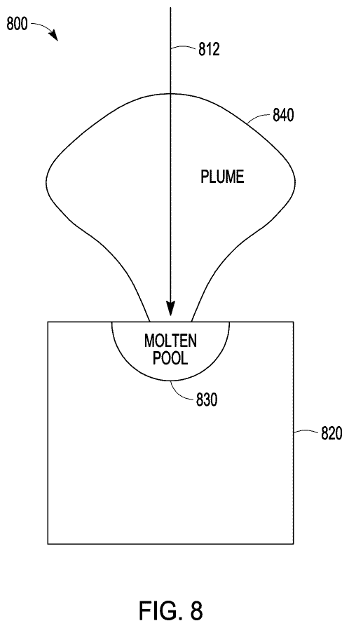

FIG. 8 illustrates an embodiment of an example arrangement 800 in which an energy beam 812 irradiates an AM part 820 forming a molten pool 830. A plume 840 can be formed over molten pool 830. Energy beam 812 can be from an electron beam source, a laser source, a focused ion beam source, or other concentrated energy beam source.

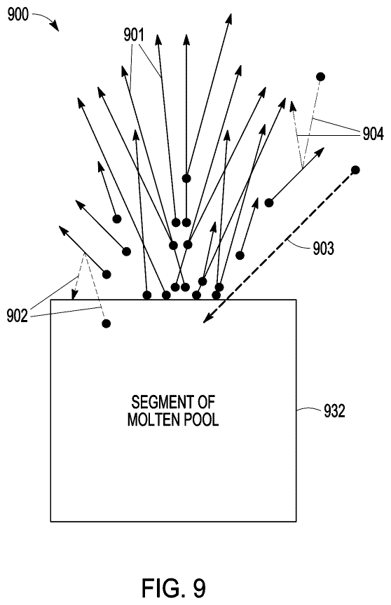

FIG. 9 illustrates an embodiment of an example segment 932 of molten pool 830 of FIG. 8 with respect to a process zone. Elements 901 represent vaporized elemental species. Elements 902 represent vaporized and recaptured elemental species. Elements 903 represent elemental species in the atmosphere, captured by molten pool 830. Elements 904 represent elemental species in the atmosphere, prevented from entering molten pool 830 by vaporized species.

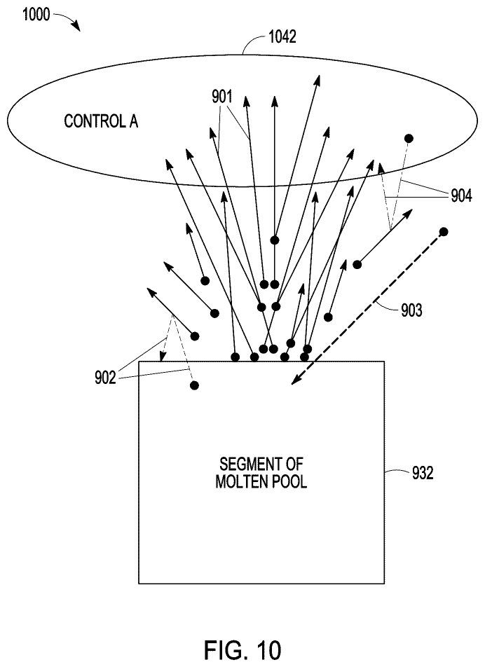

FIG. 10 illustrates an embodiment of an example segment 932 of molten pool 830 of FIG. 8 with respect to a method of controlling evaporation. Elements 901 represent vaporized elemental species. Elements 902 represent vaporized and recaptured elemental species. Elements 903 represent elemental species in the atmosphere, captured by molten pool 830. Elements 904 represent elemental species in the atmosphere, prevented from entering molten pool 830 by vaporized species. A control A 1042 can be implemented to increase concentration of vaporized elemental species from an external, sacrificial source. Control A 1042 can reduce evaporation of desired species from molten pool 830. For example, an element being volatilized above molten plume 840 of FIG. 8 by another high energy source can result in events associated with elements 902, elements 903, and elements 904 increase, while an event associated with elements 901 decreases.

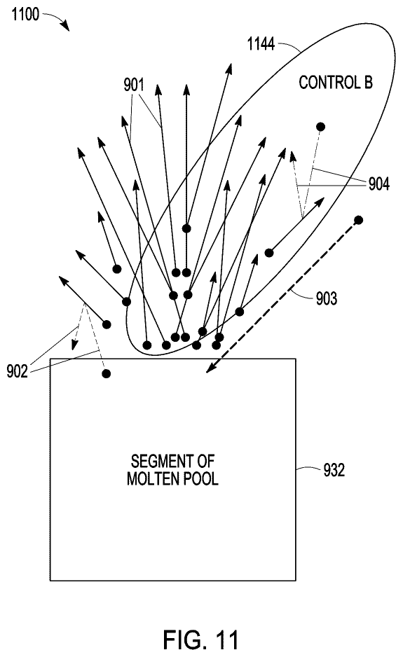

FIG. 11 illustrates an embodiment of an example segment 932 of molten pool 830 of FIG. 8 with respect to a method of controlling evaporation. Elements 901 represent vaporized elemental species. Elements 902 represent vaporized and recaptured elemental species. Elements 903 represent elemental species in the atmosphere, captured by molten pool 830. Elements 904 represent elemental species in the atmosphere, prevented from entering molten pool 830 by vaporized species. A control B 1144 can be implemented to inject species of interest for addition that bound in a compound that can be delivered in gas form. For example, metal-based organic compounds can be vapors that are activated by photons or electrons, after which the organic species are volatilized and the metallic species remains. Control B 1144 may or may not influence events associated with elements 901, elements 902, and elements 904, while an event associated with elements 903 increases.

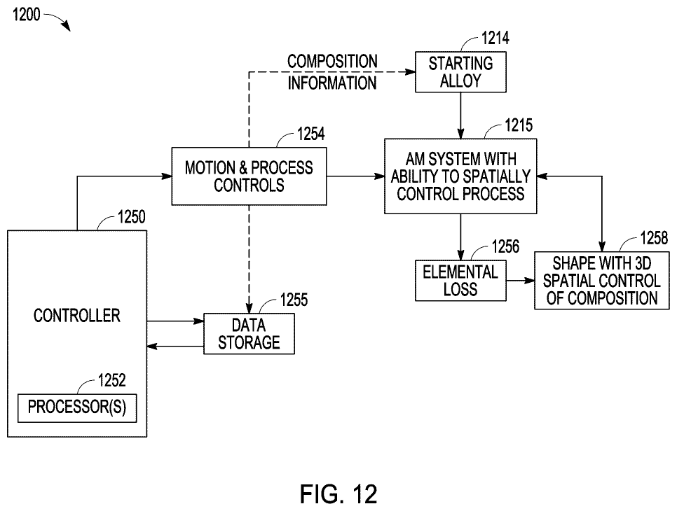

FIG. 12 illustrates an embodiment of an example system 1200 and functions of system 1200 to perform a material build using an AM system 1215. AM system 1215 can be implemented as an AM system with ability to spatially control a build process. AM system 1215 can include, but is not limited to, a commercial AM system. System 1200 can include a controller 1250, which can have one or more processors 1252, structured to provide motion and process controls 1254 to AM system 1215. Controller 1250 can be implemented, but is not limited to, a computer. Controller 1250 can be coupled to a data storage 1255, which can store one or more models associated with processing by AM system 1215. The models can use composition information regarding a starting alloy 1214 that is processed by AM system 1215. The composition information can include data regarding starting alloy 1214 and data regarding composition of the desired product. Controller 1250 can use the models and update the models associated with the AM processing of starting alloy 1214 to the desired product.

From processing and updating one or more models in data storage 1255, controller 1250 can provide AM system 1215 with motion and process controls 1254 as one or more motion and process control codes. AM system 1215 can include an energy beam source, such as beam source 610 of FIG. 6, and can be structured to configured to control formation of material, using starting alloy 1214, on a platform and to control composition of the material in a plane in a spatial manner by directly irradiating the material with an energy beam from the energy beam source, using a combination of energy scan techniques to volatilize elements of the material away from the material in an elemental loss 1256, providing a spatial variation in composition of the material. AM system 1215 can use elemental loss 1256 to shape with 3D control of composition 1258 of the material being processed from starting alloy 1214. AM system 1215 can be structured with other components of system 1200 to perform one or more material builds using one or more methods taught herein.

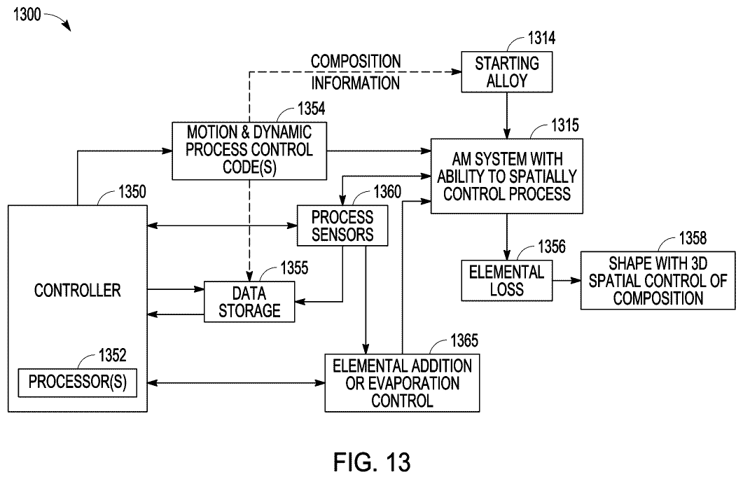

FIG. 13 illustrates an embodiment of an example system 1300 and functions of system 1300 to perform a material build using an AM system 1315. AM system 1315 can be implemented as an AM system with ability to spatially control a build process. AM system 1315 can include, but is not limited to, a commercial AM system. System 1300 can include a controller 1350, which can have one or more processors 1352, structured to provide motion and process controls 1354 to AM system 1315. Controller 1350 can be implemented, but is not limited to, a computer. Controller 1350 can be coupled to a data storage 1355, which can store one or more models associated with processing by AM system 1315. The models can use composition information regarding a starting alloy 1314 that is processed by AM system 1315. The composition information can include data regarding starting alloy 1314 and data regarding composition of the desired product. Controller 1350 can use the models and update the models associated with the AM processing of starting alloy 1314 to the desired product.

From processing and updating one or more models in data storage 1355, controller 1350 can provide AM system 1315 with motion and process controls 1354 as one or more motion and process control codes. AM system 1315 can include an energy beam source, such as beam source 610 of FIG. 6 or beam source 710 of FIG. 7, and can be structured to configured to control formation of material, using starting alloy 1314, on a platform and to control composition of the material in a plane in a spatial manner by directly irradiating the material with an energy beam from the energy beam source, using a combination of energy scan techniques to volatilize elements of the material away from the material in an elemental loss 1356, providing a spatial variation in composition of the material. AM system 1315 can use elemental loss 1356 to shape with 3D control of composition 1358 of the material being processed from starting alloy 1314.

System 1300 can include process sensors 1360 coupled to AM system 1315 to sense or measure data correlated to parameters associated with AM system 1315 processing starting alloy 1314. Process sensors 1360 can be coupled to one or more of controller 1350, data storage 1355, and an elemental addition or evaporation control 1365, where an elemental addition or evaporation control 1365 can be coupled to controller 1350. Elemental addition or evaporation control 1365 can provide a mechanism to control absorption or evaporation in directly writing to control 3D composition. Interaction between process sensors 1360, controller 1350, and elemental addition or evaporation control 1365 can be configured to provide one or more of real-time tools, predictive tools, or hybrid sensor-data controls to control evaporation or absorption. Real time techniques may include chemical measurement techniques that can use spectroscopy or non-contact, non-invasive measurement techniques, or cyber-physical hardware/software that measures a property dependent upon composition. Predictive tools can be either physical models or process-composition AI derived relationships or ML derived relationships. Such predictive tools can be processed controller 1350 using data from process sensors 1360 and models from data storage 1355. AM system 1315 can be structured with other components of system 1300 to perform one or more material builds using one or more methods taught herein.

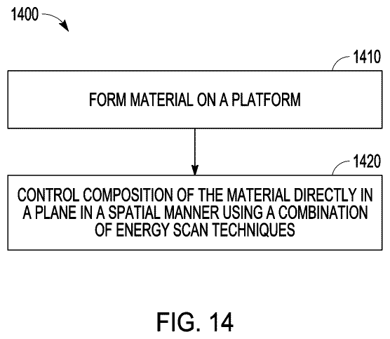

FIG. 14 is a flow diagram of features of an embodiment of an example method 1400 of performing a material build. At 1410, material is formed on a platform. At 1420, composition of the material is controlled directly in a plane in a spatial manner using a combination of energy scan techniques. The material is irradiated directly with an energy beam using the combination of energy scan techniques to volatilize elements of the material away from the material, providing a spatial variation in composition of the material. Volatilization of the elements can result from temperature reactions, pressure reactions, chemical reactions, or combinations thereof. For example, volatilization of elements of the material away from the material can include chemical transformation, such as but not limited to oxidation, that removes a component out of the alloy. The combination of energy scan techniques provides a hybrid scan technique. The combination of energy scan techniques can include a raster scan and random scan. The energy beam can be an electron beam. The material being processed can be a single starting alloy composition.

Variations of method 1400 or methods similar to method 1400 can include a number of different embodiments that may be combined depending on the application of such methods and/or the architecture of systems in which such methods are implemented. Such methods can include adjusting composition of material in another plane in a spatial manner at each level of the build in a direction vertical to the plane. Variations can include changing process parameters to tune out-of-specification feedstock compositions for the material to feedstock composition that meets the specification. Variations can include controlling resolution of the spatial variation in the composition of the material by tuning a size of a melt pool of the material.

Variations of method 1400 or methods similar to method 1400 can include controlling evaporation loss of one or more elements of the material using a real-time tool to measure properties of the material during fabrication, a predictive tool to provide models to control the evaporation loss, or one or more sensors to provide data to control the evaporation loss. Controlling evaporation loss of a given element or compound of the material can be attained by controlling a plume with a high partial pressure of the given element or compound. The plume can be from one or more metal-containing gases or a second, sacrificial volatilized source.

Variations of method 1400 or methods similar to method 1400 can include controlling absorption in forming the composition by introducing one or more metal-containing gases that is patterned into deposition of the material on the platform prior to the deposition of during the deposition. The one or more metal-containing gases can include one or more of tungsten-hexacarbonyls, molybdenum-hexacarbonyls, or chromium-hexacarbonyls. Variations can include controlling absorption in forming the composition by using a second melting/evaporation system in which metal containing vapor of the second melting/evaporation system is directed towards the material formed on the platform.

In various embodiments, an article of manufacture can comprise spatial variation in a plane of composition of the material formed by method 1400 or methods similar to method 1400. The article of manufacture can include a number of variations. In the article of manufacture, the spatial variation in a plane of composition of the material can include changes in composition with attending changes in microstructure and material state including one or more of phase, grain size, grain texture/orientation, grain boundary character distributions, or defects. In the article of manufacture, the spatial variation in a plane of composition of the material can include changes in composition that include one or more changes in thermophysical properties. The one or more changes in thermophysical properties can include changes in one or more of melting points, solid-state phase fields, transformation temperatures, or surface energies. In the article of manufacture, the spatial variation in a plane of composition of the material can include changes in clastic properties, plastic properties, thermal properties, electrical properties, optical properties, or magnetic properties. In the article of manufacture, the spatial variation in a plane of composition of the material can include changes in transus temperatures in structural alloys. In the article of manufacture, the spatial variation in a plane of composition of the material can include changes in response of the material to one or more electrochemical environments. The one or more electrochemical environments can include one or more of corrosion, oxidation, cathodic protection, anodic protection, or anodization. An article of manufacture can comprise spatial variation in a plane of composition of the material formed by any one of the variations of method 1400 or methods similar to method 1400.

In various embodiments, a system can comprise a controller to generate motion and process control codes and a manufacturing apparatus having an energy beam source. The manufacturing apparatus can be structured to receive the motion and process control codes to control formation of material on a platform and to control composition of the material in a plane in a spatial manner by directly irradiating the material with an energy beam from the energy beam source, using a combination of energy scan techniques to volatilize elements of the material away from the material, providing a spatial variation in composition of the material. The combination of energy scan techniques can be a hybrid energy scan technique. The combination of energy scan techniques can include a raster scan and random scan. The material processed by the system can be a single starting alloy composition. The energy beam source can be an electron beam source.

Variations of such a system can include a number of different embodiments that can be combined depending on the application of the system or similar systems and/or the architecture in which such systems are implemented. Such a system can include the manufacturing apparatus structured to control the combination of energy scan techniques to spatially shape the composition with three-dimensional spatial control. Such a system can include a data storage to store models to control the composition of the material using the combination of energy scan techniques.

Variations of such a system can include the manufacturing apparatus structured to use the motion and process control codes to change process parameters to tune out-of-specification feedstock compositions for the material to feedstock composition that meets the specification. Variations can include the manufacturing apparatus structured to use the motion and process control codes to control resolution of the spatial variation in the composition of the material by tuning a size of a melt pool of the material.

Variations of such a system can include one or more process sensors and an absorption control or evaporation control. The absorption control and the evaporation control can be structured to be responsive to data from the one or more process sensors. Variations can include the evaporation control structured to control evaporation loss of one or more elements of the material using a real-time tool to measure properties of the material during fabrication, a predictive tool to provide models to control the evaporation loss, or the one or more process sensors to provide data to control the evaporation loss. Variations can include the evaporation control structured to control evaporation loss of a given element or compound of the material by controlling a plume with a high partial pressure of the given element or compound. The plume can be from one or more metal-containing gases or a second, sacrificial volatilized source.

Variations can include the absorption control structured to control absorption in forming the composition by introducing one or more metal-containing gases that is patterned into deposition of the material on the platform prior to the deposition of during the deposition. The one of more metal-containing gases can include one or more of tungsten-hexacarbonyls, molybdenum-hexacarbonyls, or chromium-hexacarbonyls. Variations can include the absorption control structured to control absorption in forming the composition by using a second melting/evaporation system in which the metal containing vapor of the second melting/evaporation system is directed towards the material formed on the platform.

In various embodiments, a method of performing a material build can comprise one or more combinations of procedures of method 1400 or methods similar to method 1400. A method of performing a material build can include forming the material build by using one or more components associated with the systems discussed above. In various embodiments, a system can comprise one or more combinations of components of the systems discussed above. In various embodiments, a system can comprise one or more combinations of components to perform the operations of method 1400 or methods similar to method 1400. In various embodiments, a method of performing a material build can comprise performing one or more permutations of the operations disclosed herein, associated operations, or similar operations. In various embodiments, a system can comprise one or more permutations of components disclosed herein, associated components, or similar components. In various embodiments, a machine-readable storage device storing instructions, that when executed by one or more processors, cause a machine to perform operations, the instructions can comprise operations to perform functions associated with any features of the systems discussed above, components of the systems discussed above, associated components, or similar components, to perform methods associated with any features of method 1400 or methods similar to method 1400, associated procedures, or similar procedures, or combinations thereof.

The following are example embodiments of methods, systems, and articles of manufacture, in accordance with the teachings herein.

An example method 1 of performing a material build can comprise: forming material on a platform; and controlling composition of the material in a plane in a spatial manner by directly irradiating the material with an energy beam using a combination of energy scan techniques to volatilize elements of the material away from the material, providing a spatial variation in composition of the material, the volatilization of elements resulting from temperature reactions, pressure reactions, chemical reactions, or combinations thereof.

An example method 2 of performing a material build can include elements of example method 1 of performing a material build and can include the combination of energy scan techniques to include a raster scan and random scan.

An example method 3 of performing a material build can include elements of any preceding example methods of performing a material build and can include the material being a single starting alloy composition.

An example method 4 of performing a material build can include elements of any preceding example methods of performing a material build and can include the energy beam being an electron beam.

An example method 5 of performing a material build can include elements of any preceding example methods of performing a material build and can include adjusting composition of material in another plane in a spatial manner at each level of the build in a direction vertical to the plane.

An example method 6 of performing a material build can include elements of any preceding example methods of performing a material build and can include changing process parameters to tune out-of-specification feedstock compositions for the material to feedstock composition that meets the specification.

An example method 7 of performing a material build can include elements of any preceding example methods of performing a material build and can include controlling resolution of the spatial variation in the composition of the material by tuning a size of a melt pool of the material.

An example method 8 of performing a material build can include elements of any preceding example methods of performing a material build and can include controlling evaporation loss of one or more elements of the material using a real-time tool to measure properties of the material during fabrication, a predictive tool to provide models to control the evaporation loss, or one or more sensors to provide data to control the evaporation loss.

An example method 9 of performing a material build can include elements of any preceding example methods of performing a material build and can include controlling evaporation loss of a given element or compound of the material by controlling a plume with a high partial pressure of the given element or compound.

An example method 10 of performing a material build can include elements of example method 9 of performing a material build and any preceding example methods 1-8 of performing a material build and can include the plume being from one or more metal-containing gases or a second, sacrificial volatilized source.

An example method 11 of performing a material build can include elements of any preceding example methods of performing a material build and can include controlling absorption in forming the composition by introducing one or more metal-containing gases that is patterned into deposition of the material on the platform prior to the deposition of during the deposition.

An example method 12 of performing a material build can include elements of example method 11 of performing a material build and any preceding example methods 1-10 of performing a material build and can include the one or more metal-containing gases to include one or more of tungsten-hexacarbonyls, molybdenum-hexacarbonyls, or chromium-hexacarbonyls.

An example method 13 of performing a material build can include elements of any preceding example methods of performing a material build and can include controlling absorption in forming the composition by using a second melting/evaporation system in which metal containing vapor of the second melting/evaporation system is directed towards the material formed on the platform.

An example article of manufacture 1 can comprise spatial variation in a plane of composition of the material formed by the example method 1 of performing a material build.

An example article of manufacture 2 of can include elements of example article of manufacture 1 and can include the spatial variation in a plane of composition of the material to include change in composition with attending changes in microstructure and material state including one or more of phase, grain size, grain texture/orientation, grain boundary character distributions, or defects.

An example article of manufacture 3 can include elements of any preceding example articles of manufacture and can include the spatial variation in a plane of composition of the material to include changes in composition that include one or more changes in thermophysical properties.

An example article of manufacture 4 can include elements of example article of manufacture 3 and any preceding example articles of manufacture 1-2 and can include the one or more changes in thermophysical properties to include changes in one or more of melting points, solid-state phase fields, transformation temperatures, or surface energies.

An example article of manufacture 5 can include elements of any preceding example articles of manufacture and can include the spatial variation in a plane of composition of the material to include changes in elastic properties, plastic properties, thermal properties, electrical properties, optical properties, or magnetic properties.

An example article of manufacture 6 can include elements of any preceding example articles of manufacture and can include the spatial variation in a plane of composition of the material to include changes in transus temperatures in structural alloys.

An example article of manufacture 7 can include elements of any preceding example articles of manufacture and can include the spatial variation in a plane of composition of the material to include changes in response of the material to one or more electrochemical environments.

An example article of manufacture 8 can include elements of example article of manufacture 7 and any preceding example articles of manufacture 1-6 and can include the one or more electrochemical environments to include one or more of corrosion, oxidation, cathodic protection, anodic protection, or anodization.

An example article of manufacture 9 can include elements of any preceding example articles of manufacture and can include the spatial variation in a plane of composition of the material formed by any one of the example methods 2-13 of performing a material build.

An example system 1 can comprise a controller to generate motion and process control codes; and a manufacturing apparatus having an energy beam source, the manufacturing apparatus configured to receive the motion and process control codes to: control formation of material on a platform; and control composition of the material in a plane in a spatial manner by directly irradiating the material with an energy beam from the energy beam source, using a combination of energy scan techniques to volatilize elements of the material away from the material, providing a spatial variation in composition of the material.

An example system 2 can include elements of example system 1 and can include the combination of energy scan techniques to include a raster scan and random scan.

An example system 3 can include elements of any preceding example systems and can include the material being a single starting alloy composition.

An example system 4 can include elements of any preceding example systems and can include the energy beam source being an electron beam source.

An example system 5 can include elements of any preceding example systems and can include the manufacturing apparatus being configured to control the combination of energy scan techniques to spatially shape the composition with three-dimensional spatial control.

An example system 6 can include elements of any preceding example systems and can include a data storage to store models to control the composition of the material using the combination of energy scan techniques.

An example system 7 can include elements of any preceding example systems and can include the manufacturing apparatus being configured to use the motion and process control codes to change process parameters to tune out-of-specification feedstock compositions for the material to feedstock composition that meets the specification.

An example system 8 can include elements of any preceding example systems and can include the manufacturing apparatus being configured to use the motion and process control codes to control resolution of the spatial variation in the composition of the material by tuning a size of a melt pool of the material.

An example system 9 can include elements of any preceding example systems and can include one or more process sensors; and an absorption control or evaporation control, the absorption control and the evaporation control being responsive to data from the one or more process sensors.

An example system 10 can include elements of example system 9 and any preceding example systems 1-8 and can include the evaporation control being structured to control evaporation loss of one or more elements of the material using a real-time tool to measure properties of the material during fabrication, a predictive tool to provide models to control the evaporation loss, or the one or more process sensors to provide data to control the evaporation loss.

An example system 11 can include elements of example system 9 and any preceding example systems 1-8 and 10 and can include the evaporation control being structured to control evaporation loss of a given element or compound of the material by controlling a plume with a high partial pressure of the given element or compound.

An example system 12 can include elements of example system 11 and any preceding example systems 1-10 and can include the plume being from one or more metal-containing gases or a second, sacrificial volatilized source.

An example system 13 can include elements of example system 9 and any preceding example systems 1-8 and 11-12 and can include the absorption control being structured to control absorption in forming the composition by introducing one or more metal-containing gases that is patterned into deposition of the material on the platform prior to the deposition of during the deposition.

An example system 14 can include elements of example system 13 and any preceding example systems 1-12 and can include the one or more metal-containing gases to include one or more of tungsten-hexacarbonyls, molybdenum-hexacarbonyls, or chromium-hexacarbonyls.

An example system 15 can include elements of example system 9 and any preceding example systems 1-14 and can include the absorption control being structured to control absorption in forming the composition by using a second melting/evaporation system in which the metal containing vapor of the second melting/evaporation system is directed towards the material formed on the platform.

An example method 14 of performing a material build comprising one or more combinations of procedures of example methods 1-13 of performing a material build.

An example method 15 of performing a material build comprising forming the material build by using one or more components associated with the example systems 1-15.

An example system 16 can comprise one or more combinations of components of example systems 1-15.

An example system 17 can comprise one or more combinations of components to perform the operations of methods associated with example methods 1-13.

An example method 16 of performing a material build comprising performing one or more permutations of the operations disclosed herein, associated operations, or similar operations.

An example system 18 can comprise one or more permutations of components disclosed herein, associated components, or similar components.

An example machine-readable storage device storing instructions, that when executed by one or more processors, cause a machine to perform operations, the instructions comprising operations to: perform functions associated with any features of the example systems 1-15, components of example systems 1-15, associated components, or similar components; perform methods associated with any features of example methods 1-13, associated procedures, or similar procedures; or combinations thereof.

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. It is to be understood that the above description is intended to be illustrative, and not restrictive, and that the phraseology or terminology employed herein is for the purpose of description.

What is claimed is:

1. A method of performing a material build, the method comprising:
forming material on a platform; and
controlling composition of the material in a plane in a spatial manner by directly irradiating the material with an energy beam using a combination of energy scan techniques to volatilize elements of the material away from the material, providing a spatial variation in composition of the material, the volatilization of elements resulting from temperature reactions, pressure reactions, chemical reactions, or combinations thereof.

2. The method of claim 1, wherein the combination of energy scan techniques includes a raster scan and random scan.

3. The method of claim 1, wherein the material is a single starting alloy composition.

4. The method of claim 1, wherein the energy beam is an electron beam.

5. The method of claim 1, wherein the method includes adjusting composition of material in another plane in a spatial manner at each level of the build in a direction vertical to the plane.

6. The method of claim 1, wherein the method includes changing process parameters to tune, with respect to a specification, out-of-specification feedstock compositions for the material to feedstock composition that meets the specification.

7. The method of claim 1, wherein the method includes controlling resolution of the spatial variation in the composition of the material by tuning a size of a melt pool of the material.

8. The method of claim 1, wherein the method includes controlling evaporation loss of one or more elements of the material using a real-time tool to measure properties of the material during fabrication, a predictive tool to provide models to control the evaporation loss, or one or more sensors to provide data to control the evaporation loss.

9. The method of claim 1, wherein the method includes controlling evaporation loss of a given element or compound of the material by controlling a plume with a high partial pressure of the given element or compound.

10. The method of claim 9, wherein the plume is from one or more metal-containing gases or a second, sacrificial volatilized source.

11. The method of claim 1, wherein the method includes controlling absorption in forming the composition by introducing one or more metal-containing gases that is patterned into deposition of the material on the platform prior to the deposition of during the deposition.

12. The method of claim 11, wherein the one or more metal-containing gases include one or more of tungsten-hexacarbonyl, molybdenum-hexacarbonyl, or chromium-hexacarbonyl.

13. The method of claim 1, wherein the method includes controlling absorption in forming the composition by using a second melting/evaporation system in which metal containing vapor of the second melting/evaporation system is directed towards the material formed on the platform.

14. An article of manufacture comprising:
a platform; and
a material on the platform, the material having a spatial variation in composition in a plane, the spatial variation defined by volatilization of elements of the composition resulting from temperature reactions, pressure reactions, chemical reactions, or combinations thereof by directly irradiating the material with an energy beam using a combination of energy scan techniques to volatilize the elements of the material away from the material.

15. The article of manufacture of claim 14, wherein the spatial variation in a plane of composition of the material includes changes in composition with attending changes in microstructure and material state including one or more of phase, grain size, grain texture/orientation, grain boundary character distributions, or defects.

16. The article of manufacture of claim 14, wherein the spatial variation in a plane of composition of the material includes changes in elastic properties, plastic properties, thermal properties, electrical properties, optical properties, or magnetic properties.

17. A system comprising:
a controller to generate motion and process control codes; and
a manufacturing apparatus having an energy beam source, the manufacturing apparatus configured to receive the motion and process control codes to:
control formation of material on a platform; and
control composition of the material in a plane in a spatial manner by directly irradiating the material with an energy beam from the energy beam source, using a combination of energy scan techniques to volatilize elements of the material away from the material, providing a spatial variation in composition of the material.

18. The system of claim 17, wherein the combination of energy scan techniques includes a raster scan and random scan.

19. The system of claim 17, wherein the system includes absorption control structured to control absorption in forming the composition by introducing one or more metal-containing gases that is patterned into deposition of the material on the platform prior to the deposition of during the deposition.

20. The system of claim 19, wherein the absorption control is structured to control absorption in forming the composition by using a second melting/evaporation system in which metal containing vapor of the second melting/evaporation system is directed towards the material formed on the platform.
